(19) United States
(12) Patent Application Publication
(10) Pub. No.: US 2005/0103810 A1
(43) Pub. Date: May 19, 2005

(54) Dispenser for removing a fluid from a container

(76) Inventor: Reimund Pichler, Oelde (DE)

Correspondence Address: Law Offices of Karl Hormann, P.O. Box 381516, Cambridge, MA, 02238-1516, US

(21) Appl. No.: 10/994,120

(22) Filed: Nov. 19, 2004

(30) Foreign Application Priority Data
Nov. 19, 2003 (DE) DE 103 54 241.8

(51) Int. Cl. B67D 5/00; B67D 5/40

(52) U.S. Cl. 222/382

(57) ABSTRACT

A device for dispensing a fluid from a container provided with a substantially tubular mouthpiece provided with an elongate dispensing probe for insertion into the mouthpiece and a housing made up of two parallel parts adapted to be disposed at opposite sides of the mouthpiece, at least one of the parts being provided with a lever pivotable into resilient engagement with the mouthpiece about an axis extending normal to the axis of the housing.

### BACKGROUND OF THE INVENTION

1. Field of the Invention

The invention, in general, relates to a device for removing and dispensing a fluid from a container and, more particularly, to a device of this kind which is provided with a support for attaching a dispensing probe, the support being configured, on the one hand, as an adapter for providing a connection with a mouthpiece of the container and, on the other hand, for establishing a secure attachment of the dispensing probe to prevent it from being unintentionally withdrawn.

2. The Prior Art

Fluid dispensing devices and, more particularly, dispensing systems are known in which fluid stored in a container may be safely removed therefrom by means of an attachment or docking station. There are many reasons which make such arrangements necessary. The dispensation of chemicals for cleaning purposes as, for instance, in rinsing and washing machines as well as commercial and industrial cleaning apparatus may be mentioned as a typical example. In this connection, chemicals are often used which need be kept in large containers. The known devices are usually provided with a support or holder for docking a removal or dispensing probe to prevent the hazardous chemical from contacting a person.

Such a device is known, for instance, from DE 199 08 181 A1. The device described therein includes a dispensing arrangement consisting of a container provided with a connection or docking feature which is operatively connected with a fixed dispensing probe with needle when the container is inserted into the dispensing device. This makes it possible to remove fluid from the container without any hazard. However, the arrangement suffers from the drawback that the dispensing probe can only be connected at a fixed station and that only such containers or canisters can be used which are specially designed for, and which can function with, the dispenser.

Another prior art device known from FR 2,565,573, also consists of a holder or bracket for mounting or docking a dispensing probe. In this case the mounting bracket for the dispensing probe is structured as a clamping bow which frictionally and positively surrounds the dispensing probe and establishes a connection with the mouthpiece of the container. In this context, the disclosure teaches the connection to be formed by a resiliently supported bow element which attaches the dispensing probe as well as the device to the mouthpiece of the container. The dispensing probe is mounted in a bracket which is biased against the opening wall of the mouthpiece. The disadvantage of this arrangement that it cannot provide a secure attachment in view of the fact that both the bracket and the dispensing probe are quasi freely accessible. The disclosed arrangement does not ensure the mandated secure mounting on a mouthpiece because the dispensing probe is merely attached against the frictional bracket of the mounting bow. An unintentional shifting or moving of the probe in the bracket is, therefore, possible. Another disadvantage is seen in the complexity of operating the known holder.

### OBJECT OF THE INVENTION

It is, therefore, an object of the invention to improve a device for removing or dispensing a fluid from a container, canister or the like, relative to the mentioned prior art devices, so that fluids may safely be removed by a dispensing probe regardless of the station or location.

### BRIEF SUMMARY OF THE INVENTION

In accordance with the invention, the object is accomplished by a device for removing or dispensing a fluid from a container which is provided with a handle comprising a housing made up of at least two parts which frictionally and/or positively surround the dispensing probe and which is provided with lever-like elements pivotally mounted in at least one housing part and which by one of their lever arms are operatively connected to springs which positively and frictionally maintain their other lever arms in engagement with the mouthpiece of the container.

In an advantageous embodiment the lower section of the other lever arms are of hook-shaped configuration.

Preferably, the fulcra of the lever-like elements are arranged at the approximate center of the one housing part with an opening being provided in this area of the one housing part for receiving the dispensing probe.

In an advantageous embodiment, the housing parts enclose between them the dispensing probe and are connected by threaded elements aligned parallel to the axis of the adapter.

In consequence of the bracket for the docking of the dispensing probe being configured as an adapter which may be put into direct positive or frictional engagement with the mouthpiece of a container with the adapter establishing a connection of the dispensing probe securing it against unintentional withdrawal, fluid may be withdrawn regardless of the station or location. It will be appreciated by those skilled in the art that the adapter may thus be affixed to containers as a separate component without the need for an operative connection of the container with a separate dispensing device. The container may thus remain in its position. The dispensing probe and its cannula or hollow needle are thus securely inserted into the adapter, and the liquid to be used for a cleaning or disinfection process may be dispensed through a hose. Once the container is empty use of the same kind of liquid may continue simply by moving the adapter to another full container. Accordingly, a flexible system for dispensing media from containers or canisters is being provided.

Advantageously, the adapter essentially comprises a housing of two parts which by its at least two housing parts positively and/or frictionally surrounds the dispensing probe and is provided with lever-like elements pivotally mounted in at least one housing part and operatively connected by one of their lever arms to springs which bias the other lever arms of the lever-like elements into positive or frictional engagement with the mouthpiece of a container. This results in an interaction of engagement of the adapter with the mouthpiece of the container on the one hand and of the mounting and securing of the dispensing probe on the adapter on the other hand. Hence, the adapter satisfies two effects or conditions: First, it ensures a secure attachment of the dispensing probe and, second, safe dispensing because of the secure attachment of the adapter on the container.

### DESCRIPTION OF THE DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the sole appended sectional drawing of a dispenser in accordance with the invention.

### DETAILED DESCRIPTION OF THE PREFERRED EMBODIMENT

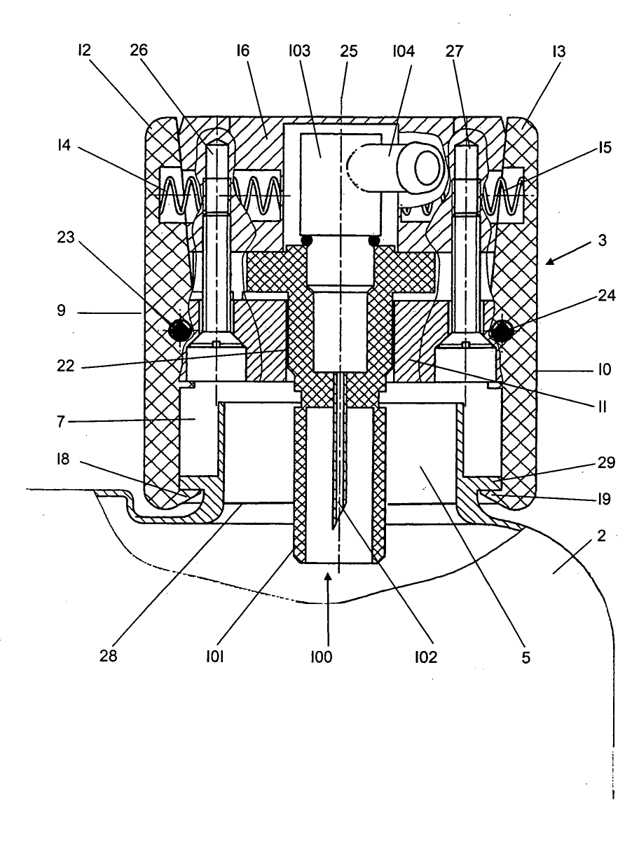

The single drawing is a sectional side view of a device for removing or dispensing a fluid or liquid from a container, canister 2, or the like schematically shown to be in operative connection with the device. The device consists of a holder or bracket 3 for docking or connecting a dispensing probe 100 of the kind known, for example, from DE 199 08 181 A1 and, more particularly, FIG. 7 thereof. As may be seen from the drawing, the holder 3 for the dispensing probe is structured as an adapter for the indicated container or canister 2. On the one hand, the adapter is positively or frictionally connected to a mouthpiece 5 of the container 2, and, on the other hand, it securely connects the dispensing probe (not shown in detail) to prevent its unintentional withdrawal. As will be described hereinafter, the connection 6 of the dispensing probe is also a frictional or positive one.

As may be seen in the sectional drawing of the adapter in particular, the adapter essentially comprises a housing 7 consisting of two parts 11 and 16. The two parts 11 and 16 are connected to each other by screws 26 and 27 disposed substantially parallel to the axis 25 of the adapter. The dispensing probe 100 is seated between the two housing parts 11 and 16. A tubular end section 101 of the probe 100 with a preferably sharp cannula or pointed hollow needle 102 extending substantially coaxially therein is inserted in a receiving bore 22 in the lower section of the housing parts 11 and 16. A holding disk provided at a middle section of the probe 100 is retained between the housing parts 11 and 16 when the probe is fully inserted or threaded into the receiving bore 22. At the upper section of the probe 100, there is threadedly mounted a cap 103 with an angularly extending tubular stub 104 terminating at its distal end in an annular bead to secure, for instance by means of a clamp, a hose (not shown).

At the lower housing parts 11 and 16 two lever-like elements 9 and 10 are pivotally mounted on pins or fulcra 23 and 24, respectively. The lever arms 12 and 13 extending upwardly from the fulcra 23 and 24 are operatively connected to springs 14 and 15 which bias the arms 12 and 13 radially outwardly. As shown in the drawing, the lower arms 18 and 19 of the lever-like elements 9 and 10 are thus forced into positive or frictional engagement with a mouthpiece 5 of the container 2. As a result of the upper arms 12 and 13 being biased in a radially outward direction by the springs 14 and 15, the ends of the lower arms 18 and 19 which are bent inwardly extend below a collar 29 surrounding the mouthpiece 5. Accordingly, the adapter is clampingly connected to the mouthpiece 5. In this clamping position, the lower margin 28 of the lower housing part 11 is disposed below the collar 29. Since in the area outside of the lever elements 9 and 10 the lower housing part is closed, the mouthpiece 5 is completely covered and protected from being accessed from outside.

In order to release the adapter from the mouthpiece 5, persons skilled in the art will know that the upper lever arms 12 and 13 need be pressed towards each other against the bias of the springs 14 and 15. The dispensing probe 100 is thus retained within the adapter so that it is securely retained therein while the adapter is moved to another container 2 without any drops of liquid which may have remained on the probe 100 coming into contact with a user.

As may be further seen from the drawing, the receiving bore 22 for the dispensing probe 100 is positioned approximately in the center section of the housing 7. It will, however, be understood by skilled artisans that the receiving bore 22 may be structured as a sleeve and extend into the mouthpiece 5 of the container 2.

1. A device for dispensing a fluid from a container provided with a substantially tubular mouthpiece, comprising:
a support comprising first and second housing parts disposed substantially parallel to each other and adapted to be seated on opposite sides of the mouthpiece;
a dispensing probe retained substantially coaxially between the first and second housing parts and adapted to be inserted into the mouthpiece;
a lever element comprising first and second longitudinally aligned arms mounted for pivotal movement in at least one of the first and second housing parts;
a spring extending substantially normal to the lever element for biasing one of the first and second arms radially outwardly and the other of the first and second arms inwardly for engagement with the mouthpiece.

2. The device in accordance with claim 1, wherein the other of the first and second arms comprises a centripetally extending section adapted to be positioned against the mouthpiece.

3. The device in accordance with claim 2, wherein the housing in an area intermediate its axial ends is provided with means for forming a bore for receiving the dispensing probe and wherein the lever element is mounted for pivotal movement about an axis disposed in the area.

4. The device in accordance with claim 3, wherein the housing parts are connected to each other by threaded members extending substantially parallel to the axis of the housing on opposite sides of the dispensing probe.
